(19) United States
(12) Patent Application Publication
(10) Pub. No.: US 2013/0027970 A1
(43) Pub. Date: Jan. 31, 2013

(54) ILLUMINATION DEVICE AND DISPLAY DEVICE INCORPORATING SAME

(71) Applicant: Takashi Ishizumi, Osaka-shi (JP)

(72) Inventor: Takashi Ishizumi, Osaka-shi (JP)

(21) Appl. No.: 13/640,063

(22) PCT Filed: Jan. 26, 2011
(86) PCT No.: PCT/JP2011/051410

§ 371 Date: Oct. 9, 2012

(30) Foreign Application Priority Data
Apr. 28, 2010 (JP) 2010-104003

(51) Int. Cl. G09F 13/18; F21V 13/12; F21V 13/02

(52) U.S. Cl. 362/606; 362/609

(57) ABSTRACT

An illumination device that can enhance the efficiency of utilization of light is provided. This illumination device includes LEDs (15) that are arranged opposite the light entrance surface (12c) of a light guide plate (12) and an optical path (LP) partitioned by an optically reflective surface (5a) and an optically reflective surface (6a). In at least an optical path region (A) on the side of the light entrance surface (12c) of the entire region of the optical path (LP), the optically reflective surface (5a) and the optically reflective surface (6a) are arranged parallel to each other, and a distance between the optically reflective surface (5a) and the optically reflective surface (6a) in an LED arrangement region (LA) is made greater than a distance between the optically reflective surface (5a) and the optically reflective surface (6a) in the optical path region (A).

### TECHNICAL FIELD

The present invention relates to an illumination device and a display device incorporating such as an illumination device.

### BACKGROUND ART

In a liquid crystal display device which is one type of display device, since a liquid crystal display panel displaying an image is not luminous, an illumination device called a backlight unit is provided on the back surface side of the liquid crystal display panel (the opposite side to the display surface side of the liquid crystal display panel), the back surface side of the liquid crystal display panel is illuminated by the backlight unit and thus a display operation is performed.

The backlight unit provided in the liquid crystal display device is broadly divided into two types, a direct type and an edge-light type.

The configuration thereof will be described brightly; in the direct type backlight unit, a light source is arranged directly below a liquid crystal display panel, and light emitted from the light source illuminates the liquid crystal display panel through optical sheets (such as a diffusion sheet and a lens sheet).

On the other hand, in the edge-light type backlight unit, a light guide plate is arranged directly below a liquid crystal display panel, and a light source is arranged opposite a predetermined side end surface of the light guide plate. In an illumination operation of the edge-light type backlight unit, when the light source emits light, the light is introduced into the light guide plate through the predetermined side end surface. Then, the light introduced into the light guide plate is repeatedly reflected, is emitted through the front surface (the surface facing the side of the liquid crystal display panel) of the light guide plate and thereafter illuminates the liquid crystal display panel through optical sheets.

These two types of backlight units are used according to the usage; in a liquid crystal display device that is specifically designed to have a small thickness, the edge-light backlight unit suitable for reducing the thickness is employed.

Incidentally, an edge-light type backlight unit in which the thickness of a light guide plate in an effective display region is decreased to reduce its thickness is conventionally proposed (for example, see patent document 1).

Specifically, in the conventionally proposed edge-light type backlight unit, as shown in FIG. 9, a light guide plate 101 is arranged so as to cover an effective display region A1 and a non-effective display region A2. Among a plurality of side end surfaces of the light guide plate 101, the side end surface on the side of the non-effective display region A2 is used as a light entrance surface 101a, and a light source 102 is arranged opposite the light entrance surface 101a of the light guide plate 101.

The thickness of the light guide plate 101 in the effective display region A1 is made smaller than that of the light guide plate 101 in the non-effective display region A2; furthermore, the thickness of the light guide plate 101 in the non-effective display region A2 is decreased toward the effective display region A1 such that it is inclined. If the thickness of the light guide plate 101 is made uniformly small over the entire region, since the width of the light entrance surface 101a of the light guide plate 101 in the thickness direction is decreased, light that does not enter the light entrance surface 101a of the light guide plate 101 is increased. Hence, in the edge-light type backlight unit described above, only the thickness of the light guide plate 101 in the effective display region A1 is decreased.

In the conventionally proposed edge-light type backlight unit, when light is emitted from the light source 102, the light from the light source 102 enters the light guide plate 101 through the light entrance surface 101a of the light guide plate 101. Then, the light guided into the light guide plate 101 travels toward the effective display region A1 while being repeatedly reflected in the non-effective display region A2.

### RELATED ART DOCUMENT

### Patent Document

Patent document 1: JP-A-2006-133274

### DISCLOSURE OF THE INVENTION

### Problems to be Solved by the Invention

However, in the conventionally proposed edge-light type backlight unit, over the non-effective display region A2, one surface of the light guide plate 101 is an inclined surface 101b. Hence, in part of light reflected off the inclined surface 101b of the light guide plate 101, its advancing angle (the angle formed with the direction of the normal to the light entrance surface 101a of the light guide plate 101) rises up, and the part of light fails to travel to the effective display region A1 and returns to the side of the light source 102. In other words, the lost light is increased, and thus the efficiency of utilization of light is disadvantageously reduced.

The present invention is made to overcome the forgoing problem; an object of the present invention is to provide an illumination device that can increase the efficiency of utilization of light and a display device incorporating such an illumination device.

### Means for Solving the Problem

To achieve the above object, according to a first aspect of the present invention, there is provided an illumination device including: a light guide plate which includes a front surface facing a side of an illuminated member, a back surface that is an opposite surface of the front surface and a plurality of side end surfaces connecting the front surface and the back surface, and in which a predetermined side end surface of the side end surfaces is a light entrance surface; a light source which is arranged a predetermined distance away from the light entrance surface of the light guide plate so as to face the light entrance surface; and an optical path which is formed of a space partitioned by a first optically reflective surface reaching a side of the light entrance surface of the light guide plate on a side of the front surface from an arrangement region of the light source and a second optically reflective surface reaching a side of the light entrance surface of the light guide plate on a side of the back surface from the arrangement region of the light source, and through which light from the light source is guided to the light entrance surface of the light guide plate. In the illumination device, in at least an optical path region, of the entire optical path, on a side of the light entrance surface of the light guide plate, the first optically reflective surface and the second optically reflective surface are arranged parallel to each other, and a distance between the first optically reflective surface and the second optically reflective surface in the arrangement region of the light source is made greater than a distance between the first optically reflective surface and the second optically reflective surface in the optical path region on the side of the light entrance surface of the light guide plate.

In the illumination device of the first aspect, as described above, in at least the optical region, of the entire region of the optical path, on the side of the light entrance surface of the light guide plate, the first optically reflective surface and the second optically reflective surface are arranged parallel to each other, and thus the light emitted from the light source travels in the optical path toward the light entrance surface of the light guide plate while being repeatedly reflected between the first optically reflective surface and the second optically reflective surface. Here, it is difficult for the advancing angle (the angle formed with the direction of the normal to the light entrance surface of the light guide plate) of the light travelling in the optical path to rise up. Hence, the amount of light that changes the direction of travel back to the direction toward the side of the light source is reduced, and thus the amount of light that reaches the light entrance surface of the light guide plate is increased. Thus, it is possible to increase the light entrance efficiency of the light entrance surface of the light guide plate. In other words, it is possible to enhance the efficiency of utilization of light.

In the illumination device of the first aspect, as described above, the distance between the first optically reflective surface and the second optically reflective surface in the arrangement region of the light source is set greater than the distance between the first optically reflective surface and the second optically reflective surface in the optical path region of the light guide plate on the side of the light entrance surface, and thus a certain amount of space is acquired around the light source. Hence, it is possible to reduce the occurrence of a problem in which the light source makes contact with other members due to the thermal expansion of various members and a low accuracy of assembly mounting. In this way, it is possible to prevent the breakage of the light source.

In the illumination device of the first aspect, a first portion of the first optically reflective surface and a second portion of the second optically reflective surface are arranged parallel to each other, and the first portion and the second portion are continuously extended from the side of the light entrance surface of the light guide plate to a side of the light source. In this configuration, the proportion of the optical path region (region where the first optically reflective surface and the second optically reflective surface are arranged parallel to each other) partitioned by the first portion and the second portion with respect to the entire region of the optical path is increased. Hence, it is possible to effectively increase the light entrance efficiency of the light entrance surface of the light guide plate.

In this case, preferably, the first portion and the second portion are continuously extended from the side of the light entrance surface of the light guide plate to the side of the light source such that a distance from an end of the optical path region, on the side of the light source, partitioned by the first portion and the second portion to the light source is set equal to or more than 0 mm but equal to or less than 0.5 mm. In particular, the distance from the end of the optical path region, on the side of the light source, partitioned by the first portion and the second portion to the light source is more preferably set equal to or more than 0 mm but equal to or less than 0.1 mm. The reason for this will be described in detail in an embodiment which will be discussed later.

In the illumination device of the first aspect, at least one of the first optically reflective surface and the second optically reflective surface preferably has a regular-reflection characteristic. In this configuration, the reflection of light entering the first optically reflective surface and the second optically reflective surface in various directions can be reduced, with the result that the amount of light that changes the direction of travel back to the direction toward the side of the light source is more reduced. Thus, it is possible to further increase the light entrance efficiency of the light entrance surface of the light guide plate. In order to increase the light entrance efficiency of the light entrance surface of the light guide plate, it is most preferable to make both the first optically reflective surface and the second optically reflective surface have the regular-reflection characteristic.

In the illumination device of the first aspect, when an optical sheet which is arranged on the front surface of the light guide plate facing the side of the illuminated member is further included, the optical sheet is preferably displaced in a direction away from the light source with respect to the light guide plate such that a side end surface of the optical sheet on the side of the light source is prevented from being flush with the light entrance surface of the light guide plate. In this configuration, even when the optical sheet is arranged on the front surface of the light guide plate, the amount of light (lost light) which does not enter the light entrance surface of the light guide plate, which enters the side end surface of the optical sheet and which is absorbed and introduced is reduced. Accordingly, it is possible to increase the light entrance efficiency of the light entrance surface of the light guide plate.

Preferably, in the configuration where the optical sheet is arranged on the front surface of the light guide plate facing the side of the illuminated member, a holding member for holding the light guide plate and the optical sheet is further included, a step is formed in the holding member, and the front surface of the light guide plate facing the side of the illuminated member is pressed with a convex surface of the step of the holding member and a surface of the optical sheet facing the illuminated member is pressed with a concave surface of the step of the holding member. In this configuration, even when the optical sheet is displaced in the direction away from the light source with respect to the light guide plate, the light guide plate and the optical sheet are easily held with the holding member. Furthermore, since the travel of light toward the side of the side end surface of the optical sheet is prevented by the step of the holding member, it is possible to easily reduce the leakage of light to the side of the side end surface of the optical sheet.

According to a second aspect of the present invention, there is provided a display device including the illumination device of the first aspect and a display panel which is illuminated by the illumination device. In this configuration, it is possible to easily enhance the efficiency of utilization of light.

### Advantages of the Invention

As described above, according to the present invention, it is possible to easily obtain the illumination device and the display device that can enhance the efficiency of utilization of light.

### BRIEF DESCRIPTION OF DRAWINGS

FIG. 1 An exploded perspective view of a display device (illumination device) according to an embodiment of the present invention;

FIG. 2 A cross-sectional view of the display device (illumination device) shown in FIG. 1;

FIG. 3 A diagram illustrating an evaluation for checking the superiority of the present invention;

FIG. 4 A diagram illustrating the evaluation for checking the superiority of the present invention;

FIG. 5 A diagram illustrating the evaluation for checking the superiority of the present invention;

FIG. 6 A diagram illustrating the evaluation for checking the superiority of the present invention;

FIG. 7 A diagram illustrating the evaluation for checking the superiority of the present invention;

FIG. 8 A diagram illustrating the evaluation for checking the superiority of the present invention; and

FIG. 9 A diagram illustrating a conventional problem.

### DESCRIPTION OF EMBODIMENTS

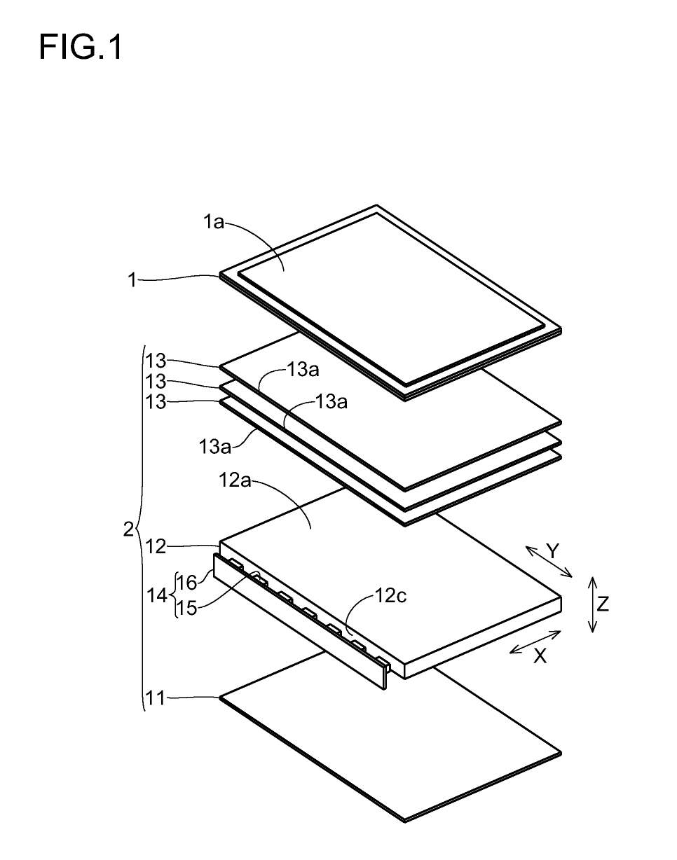

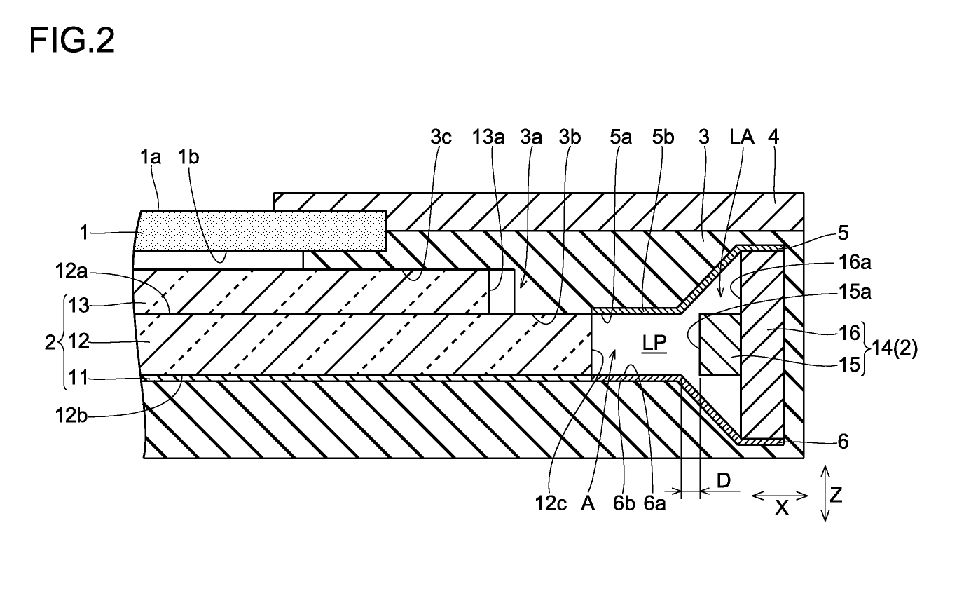

An example of the configuration of a display device according to the present invention will be describe below with reference to FIGS. 1 and 2.

This display device is a liquid crystal display device; as shown in FIGS. 1 and 2, the display device incorporates at least a liquid crystal display panel 1 that includes a display surface (surface formed with a plurality of pixels arranged in a matrix) 1a and an LED backlight unit 2 provided on the side of the back surface 1b opposite to the side of the display surface 1a of the liquid crystal display panel 1. Although they are not shown in the figure, a panel drive circuit is connected to the liquid crystal display panel 1, and an LED drive circuit is connected to the LED backlight unit 2. The optical characteristic (transmittance) of the liquid crystal display panel 1 is changed for each pixel, and backlight from the LED backlight unit 2 illuminates the side of the back surface 1b of the liquid crystal display panel 1, and thus a desired image is displayed on the display surface 1a of the liquid crystal display panel 1. The liquid crystal display panel 1 is an example of a “display panel” according to the present invention; the LED backlight unit 2 is an example of an “illumination device” according to the present invention.

In the specific configuration, the liquid crystal display panel 1 includes a liquid crystal layer, a pair of glass substrates (an active matrix substrate and an opposite substrate) and polarization plates. The liquid crystal layer is sandwiched between the pair of glass substrates, and the polarization plates are arranged on the opposite surfaces of the pair of glass substrates to the side of the liquid crystal layer.

The LED backlight unit 2 includes an optically reflective sheet 11, a light guide plate 12, optical sheets 13 and an LED module 14.

The optically reflective sheet 11 is a sheet that has a diffusion reflection characteristic, and covers the back surface 12b of the light guide plate 12, which will be described later. Thus, the leakage of light from the back surface 12b of the light guide plate 12 is reduced, and, furthermore, light is easily distributed over the entire region within the light guide plate 12. Although a white polyethylene terephthalate (PET) is generally used as a constituent material of the optically reflective sheet 11, it may be changed according to the usage.

The light guide plate 12 is formed of a transparent material (such as an acryl or a polycarbonate, which is not particularly limited), and has a front surface 12a, the back surface 12b that is the opposite surface thereof, the four side end surfaces connecting the front surface 12a and the back surface 12b. The light guide plate 12 is arranged on the optically reflective sheet 11; the front surface 12a is made to face the side of the liquid crystal display panel 1, and the back surface 12b is made to face the side of the optically reflective sheet 11. In this way, the back surface 12b of the light guide plate 12 is covered with the optically reflective sheet 11.

The front surface 12a of the light guide plate 12 functions as the light emitting surface; a predetermined side end surface 12c of the four side end surfaces functions as the light entrance surface. In other words, light is introduced into the light guide plate 12 through the predetermined side end surface 12c of the light guide plate 12, and the light is emitted through the front surface 12a of the light guide plate 12 to the side of the liquid crystal display panel 1. In the following description, the front surface 12a of the light guide plate 12 is referred to as a light emitting surface 12a, and the predetermined side end surface 12c of the light guide plate 12 is referred to as a light entrance surface 12c.

Needless to say, as the thickness (the width of the light entrance surface 12c in the Z direction) of the light guide plate 12 is increased, the light entrance efficiency of the light entrance surface 12c of the light guide plate 12 is increased. However, if the thickness (the width of the light entrance surface 12c in the Z direction) of the light guide plate 12 is excessively increased, while the light entrance efficiency of the light entrance surface 12c of the light guide plate 12 is increased, it is difficult to reduce the thickness of the LED backlight unit 2. Hence, in order to reduce the thickness of the LED backlight unit 2 and increase the light entrance efficiency of the light entrance surface 12c of the light guide plate 12, it is preferable to make the thickness (the width of the light entrance surface 12c in the Z direction) of the light guide plate 12 coincide with the width of an LED 15, which will be described later, in the Z direction. Naturally, the thickness (the width of the light entrance surface 12c in the Z direction) of the light guide plate 12 may be somewhat greater than the width of the LED 15 in the Z direction.

The optical sheets 13 include a diffusion sheet, a lens sheet and a DBEF sheet (reflective polarization sheet), and are arranged on the light emitting surface 12a of the light guide plate 12. With the function of the optical sheets 13, the diffusion, collection and the like of light emitted from the light emitting surface 12a of the light guide plate 12 are performed. The diffusion sheet, the lens sheet and the DBEF sheet described above are simply an example; the type and number of sheets used can be changed according to the usage.

The LED module 14 is designed to generate light that is introduced into the light guide plate 12, and has top-view type LEDs (light-emitting diodes) 15 as a light source. The structure of the LED 15 is not particularly limited; for example, an LED obtained by combining an LED chip emitting blue light and a fluorescent member absorbing blue light and emitting yellow fluorescent light can be considered as an example. In such a structure, the blue light and the yellow light are mixed, and thus light emitted from the LED 15 becomes pseud-white light.

The LED module 14 includes a plurality of LEDs 15, and the LEDs 15 generate light. The LEDs 15 are mounted on the mounting surface 16a of a substrate 16 that extends in the Y direction and that is formed substantially in the shape of a strip of paper, and thus the LEDs 15 are formed into a module; the LEDs 15 are aligned in the Y direction. In order to allow the mounting of the LEDs 15 on the mounting surface 16a of the substrate 16, the width of the substrate 16 in the Z direction is made greater than the width of the LED 15 in the Z direction, and furthermore, the width of the substrate 16 in the Z direction is made greater than the thickness (the width of the light entrance surface 12c in the Z direction) of the light guide plate 12. Since the LED 15 is a top-view type, with the LED 15 mounted on the mounting surface 16a of the substrate 16, the direction of the mounting surface 16a of the substrate 16 coincides with the direction of the light-emitting surface 15a of the LED 15.

The LED module 14 is arranged on the side of the light entrance surface 12c of the light guide plate 12, and thus the light-emitting surface 15a of the LED 15 is arranged a predetermined distance away from the light entrance surface 12c of the light guide plate 12 so as to face the light entrance surface 12c. In this way, when light is emitted from the LED 15, the light enters the light guide plate 12 through the light entrance surface 12c of the light guide plate 12.

The individual members of the LED backlight unit 2 are fitted to and held by an enclosure (which corresponds to a “holding member” of the present invention) 3 as shown in FIG. 2. Furthermore, the liquid crystal display panel 1 is mounted on the enclosure 3 such that the back surface 1b faces the side of the LED backlight unit 2, and, in this state, the liquid crystal display panel 1 is held by being pressed with a bezel 4. For ease of understanding of the features of the present invention, the shapes of the enclosure 3 and the bezel 4 are simplified and shown in FIG. 2. Hence, the shapes of the enclosure 3 and the bezel 4 are not limited to the shapes shown in FIG. 2.

The enclosure 3 is shaped such that, when the constituent members of the LED backlight unit 2 are fitted, a space is produced between the light entrance surface 12c of the light guide plate 12 and the mounting surface 16a of the substrate 16. A space between the light entrance surface 12c of the light guide plate 12 and the light-emitting surface 15a of the LEDs 15 allows the light from the light-emitting surface 15a of the LED 15 to be guided toward the light entrance surface 12c of the light guide plate 12. In other words, the space between the light entrance surface 12c of the light guide plate 12 and the light-emitting surface 15a of the LEDs 15 within the enclosure 3 is made to serve as an optical path LP.

A section of the optical path LP in the Z direction is formed by a pair of optically reflective surfaces 5a and 6a facing each other in the Z direction, and thus the travel of the light emitted from the LED 15 in the Z direction is regulated. The optically reflective surfaces 5a and 6a are respectively examples of a “first optically reflective surface” and a “second optically reflective surface” according to the present invention.

These optically reflective surfaces 5a and 6a are respectively formed with the surfaces of optically reflective sheets 5 and 6 that face each other in the Z direction; the optically reflective sheet 5 having the optically reflective surface 5a is adhered to a predetermined portion of the enclosure 3, and the optically reflective sheet 6 having the optically reflective surface 6a is adhered to a portion that faces, in the Z direction, the portion of the enclosure 3 to which the optically reflective sheet 5 is adhered. The optically reflective sheet 5 having the optically reflective surface 5a is extended to reach the side of the light entrance surface 12c of the light guide plate 12 on the side of the light emitting surface 12a from an LED arrangement region (region on one end side of the substrate 16 in the Z direction) LA that is a region where the LED module 14 is arranged; the optically reflective sheet 6 having the optically reflective surface 6a is extended to reach the side of the light entrance surface 12c of the light guide plate 12 on the side of the back surface 12b from the LED arrangement region (region on the other end side of the substrate 16 in the Z direction) LA.

Here, in the present embodiment, in a predetermined optical path region A, of the entire optical path LP, that includes at least an optical path region on the side of the light entrance surface 12c of the light guide plate 12, the optically reflective surfaces 5a and 6a are arranged parallel to each other and parallel to the direction of the normal to the light entrance surface 12c of the light guide plate 12. When a portion 5b of the optically reflective surface 5a and a portion 6b of the optically reflective surface 6a are assumed to be arranged parallel to each other, the portion 5b of the optically reflective surface 5a is substantially flush with the light emitting surface 12a of the light guide plate 12, and the portion 6b of the optically reflective surface 6a is substantially flush with the back surface 12b of the light guide plate 12. Specifically, the distance in the Z direction between the portion 5b of the optically reflective surface 5a and the portion 6b of the optically reflective surface 6a is set substantially equal to the thickness (the width of the light entrance surface 12c in the Z direction) of the light guide plate 12. The portion 5b of the optically reflective surface 5a and the portion 6b of the optically reflective surface 6a are respectively examples of a “first portion” and a “second portion” according to the present invention.

The portion 5b of the optically reflective surface 5a and the portion 6b of the optically reflective surface 6a arranged parallel to each other are continuously extended from the side of the light entrance surface 12c of the light guide plate 12 to the side of the LED 15. A distance D, in the X direction, from the end of the predetermined optical path region (region partitioned by the portion 5b of the optically reflective surface 5a and the portion 6b of the optically reflective surface 6a) A on the side of the LED 15 to the light-emitting surface 15a of the LED 15 is set at about 0.1 mm.

When the setting is made as described above, the portion 5b of the optically reflective surface 5a and the portion 6b of the optically reflective surface 6a arranged parallel to each other approach the vicinity of the light-emitting surface 15a of the LED 15. However, since, between such a place and the LED arrangement region LA, the size of the substrate 16 is limited, the distance between the optically reflective surface 5a and the optically reflective surface 6a is gradually increased. Specifically, with respect to the optically reflective surface 5a, the end of the portion 5a on the side of the LED 15 is a starting point, and the optically reflective surface 5a is inclined so as to extend away from the optically reflective surface 6a toward one end side of the substrate 16 in the Z direction; with respect to the optically reflective surface 6a, the end of the portion 6b on the side of the LED 15 is a starting point, and the optically reflective surface 6a is inclined so as to extend away from the optically reflective surface 5a toward the other end side of the substrate 16 in the Z direction. Hence, the distance between the optically reflective surface 5a and the optically reflective surface 6a in the LED arrangement region LA is greater than the distance between the optically reflective surface 5a and the optically reflective surface 6a in the predetermined optical path region A.

In the present embodiment, the optically reflective sheet 5 (the optically reflective surface 5a) and the optically reflective sheet 6 (the optically reflective surface 6a) are formed of the same highly reflective material; both of them have not a diffusion reflection characteristic but a high regular-reflection characteristic. Examples of the sheet formed of the highly reflective material having the high regular-reflection characteristic include “ESR” made by Sumitomo 3M Limited. As another example, an Ag sheet or the like can be used.

Furthermore, although, in the present embodiment, the optical sheets 13 are arranged on the light emitting surface 12a of the light guide plate 12, the side end surface 13a of the optical sheets 13 on the side of the LED 15 is not flush with the light entrance surface 12c of the light guide plate 12. In other words, the optical sheets 13 are displaced in the X direction with respect to the light guide plate 12 so as to move away from the LED 15. In the present embodiment, in order to hold the light guide plate 12 and the optical sheets 13 displaced in the X direction from each other, a step 3a is formed in a place of the enclosure 3 where the light guide plate 12 and the optical sheets 13 are held. The outer edge of the light emitting surface 12a of the light guide plate 12 is pressed with the convex surface 3b of the step 3a. With respect to the optical sheets 13, the outer edge of the front surface of the optical sheets 13 located closest to the side of the liquid crystal display panel 1 is pressed with the concave surface 3c of the step 3a of the enclosure 3.

In the present embodiment, as described above, in the predetermined optical path region A including, of the entire region of the optical path LP, at least the optical region on the side of the light entrance surface 12c of the light guide plate 12, the optically reflective surfaces 5a and 6a are arranged parallel to each other, and thus the light emitted from the LED 15 travels in the optical path LP toward the light entrance surface 12c of the light guide plate 12 while being repeatedly reflected between the optically reflective surface 5a and the optically reflective surface 6a. Here, it is difficult for the advancing angle (the angle formed with the direction of the normal to the light entrance surface 12c of the light guide plate 12) of the light travelling in the optical path LP to rise up. Hence, the amount of light that changes the direction of travel back to the direction toward the side of the LED 15 is reduced, and thus the amount of light that reaches the light entrance surface 12c of the light guide plate 12 is increased. Thus, it is possible to increase the light entrance efficiency of the light entrance surface 12c of the light guide plate 12. In other words, it is possible to enhance the efficiency of utilization of light.

In the present embodiment, as described above, the distance in the Z direction between the optically reflective surface 5a and the optically reflective surface 6a in the LED arrangement region LA is set greater than the distance in the Z direction between the optically reflective surface 5a and the optically reflective surface 6a in the predetermined optical path region A. This is because of the limitation of the size of the substrate 16; as a result, a certain amount of space is acquired around the LED 15 that is mounted on the mounting surface 16a of the substrate 16. Thus, it is possible to reduce the occurrence of a problem in which the LED 15 makes contact with other members due to the thermal expansion of various members and a low accuracy of assembly mounting. In this way, it is possible to prevent the breakage of the LED 15.

In the present embodiment, as described above, the portion 5b of the optically reflective surface 5a and the portion 6b of the optically reflective surface 6a arranged parallel to each other are continuously extended from the side of the light entrance surface 12c of the light guide plate 12 to the side of the LED 15, and thus the proportion of the predetermined optical path region A partitioned by the portion 5b of the optically reflective surface 5a and the portion 6b of the optically reflective surface 6a with respect to the entire region of the optical path LP is increased. Hence, it is possible to effectively increase the light entrance efficiency of the light entrance surface 12c of the light guide plate 12.

In this case, the distance D, in the X direction, from the end of the predetermined optical path region (region partitioned by the portion 5b of the optically reflective surface 5a and the portion 6b of the optically reflective surface 6a) A on the side of the LED 15 to the light-emitting surface 15a of the LED 15 is set at 0.1 mm, and thus it is possible to easily increase the light entrance efficiency of the light entrance surface 12c of the light guide plate 12. It is found that the distance D, in the X direction, from the end of the predetermined optical path region A on the side of the LED 15 to the light-emitting surface 15a of the LED 15 is set equal to or more than 0 mm but equal to or less than 0.5 mm, and thus the light entrance efficiency of the light entrance surface 12c of the light guide plate 12 is increased whereas it is set equal to or more than 0 mm but equal to or less than 0.1 mm, and thus the light entrance efficiency of the light entrance surface 12c of the light guide plate 12 is more increased. The details thereof will be described later.

Furthermore, the distance, in the X direction, from the end of the predetermined optical path region (region partitioned by the portion 5b of the optically reflective surface 5a and the portion 6b of the optically reflective surface 6a) A on the side of the LED 15 to the light-emitting surface 15a of the LED 15 is set at 0.1 mm, and thus a certain amount of space is produced both between the LED 15 and the portion 5b of the optically reflective surface 5a and between the LED 15 and the portion 6b of the optically reflective surface 6a. Thus, it is possible to reduce the occurrence of a problem in which the LED 15 makes contact with other members due to the thermal expansion of various members and a low accuracy of assembly mounting. In other words, it is possible to minimize the breakage of the LED 15.

In the present embodiment, as described above, both the optically reflective surfaces 5a and 6a have the regular-reflection characteristic, and thus the reflection of light entering the optically reflective surfaces 5a and 6a in various directions can be reduced, with the result that the amount of light that changes the direction of travel back to the direction toward the side of the LED 15 is more reduced. Thus, it is possible to further increase the light entrance efficiency of the light entrance surface 12c of the light guide plate 12. If only any one of the optically reflective surfaces 5a and 6a has the regular-reflection characteristic, a certain level of effect can be obtained though the effect is slightly lower than the case where both the optically reflective surfaces 5a and 6a have the regular-reflection characteristic.

In the present embodiment, as described above, the optical sheets 13 arranged on the light emitting surface 12a of the light guide plate 12 are displaced in the X direction with respect to the light guide plate 12 so as to move away from the LED 15, and thus the side end surface 13a of the optical sheets 13 on the side of the LED 15 is prevented from being flush with the light entrance surface 12c of the light guide plate 12, with the result that the amount of light (lost light) which does not enter the light entrance surface 12c of the light guide plate 12, which enters the side end surface 13a of the optical sheets 13 and which is absorbed and introduced is reduced. Accordingly, it is possible to increase the light entrance efficiency of the light entrance surface 12c of the light guide plate 12.

When the optical sheets 13 arranged on the light emitting surface 12a of the light guide plate 12 are displaced in the X direction with respect to the light guide plate 12 so as to move away from the LED 15, the step 3a is formed in the enclosure 3 holding the light guide plate 12, the optical sheets 13 and the like, and thus it is possible to press the light guide plate 12 with the convex surface 3b of the step 3a of the enclosure 3 and press the optical sheets 13 with the concave surface 3c of the step 3a of the enclosure 3. In other words, the light guide plate 12 and the optical sheets 13 are easily held with the enclosure 3. Furthermore, since the travel of light toward the side of the side end surface 13a of the optical sheets 13 is prevented by the step 3a of the enclosure 3, it is possible to easily reduce the leakage of light to the side of the side end surface 13a of the optical sheets 13.

The results of an evaluation performed for checking the superiority of the present invention will be described below.

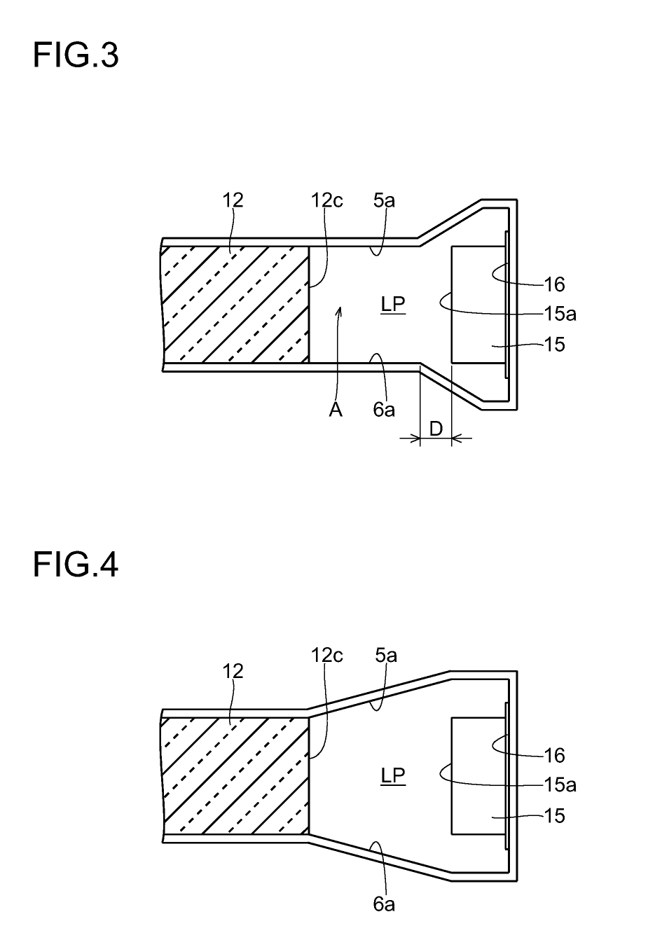

How the light entrance efficiency of the light entrance surface 12c of the light guide plate 12 was affected by increasing and decreasing, in a configuration shown in FIG. 3, the proportion of the predetermined optical path region (region where the optically reflective surfaces 5a and 6a are arranged parallel to each other) A with respect to the entire region of the optical path LP was evaluated.

Specifically, the distance D from the end of the predetermined optical path region A on the side of the LED 15 to the light-emitting surface 15a of the LED 15 was changed in four steps (2 mm, 0.5 mm, 0.1 mm and 0 mm), and the light entrance efficiency of the light entrance surface 12c of the light guide plate 12 was checked in each step. Their results are shown in Table 1.

TABLE 1

| Distance (mm) | 2 | 0.5 | 0.1 | 0 |
|---|---|---|---|---|
| Light entrance efficiency (%) | 68.90 | 83.30 | 89.20 | 89.80 |
| Relative ratio | 1.00 | 1.21 | 1.29 | 1.30 |

With reference to Table 1, the light entrance efficiency when the distance D was set at 2 mm was 68.90%. On the other hand, the light entrance efficiency when the distance D was set at 0.5 mm was 83.30%; the light entrance efficiency when the distance D was set at 0.1 mm was 89.20%. Furthermore, when the distance D was 0 mm (when the optically reflective surfaces 5a and 6a are arranged parallel to each other in the entire region of the optical path LP), the light entrance efficiency was the highest, and its value was 89.80%. This confirms that the proportion of the predetermined optical path region A with respect to the entire region of the optical path LP is increased (the distance D is set equal to or more than 0 mm but equal to or less than 0.5 mm), and thus it is possible to increase the light entrance efficiency.

As is obvious from what has been described above, it is most useful for increasing the light entrance efficiency to set the distance D at 0 mm. However, even when the distance D is 0.5 mm, about 93% of the light entrance efficiency when the distance D is 0 mm can be obtained; in particular, when the distance D is 0.1 mm, about 99% of the light entrance efficiency when the distance D is 0 mm can be obtained. In other words, the distance D is made to approach 0 mm as much as possible, and thus the light entrance efficiency that is little different from the light entrance efficiency when the distance D is 0 mm can be obtained. Hence, even when it is difficult to set the distance D at 0 mm due to various limitations, if it is possible to set the distance D equal to or less than 0.5 mm, it is possible to increase the light entrance efficiency.

How the light entrance efficiency of the light entrance surface 12c of the light guide plate 12 was affected by changing, in a configuration shown in FIG. 4, the reflection characteristic (see Table 2) of the optically reflective surfaces 5a and 6a partitioning the optical path LP was evaluated. In Table 2, regular-reflection characteristic RC1 indicates a reflection characteristic when “ESR” made by Sumitomo 3M Limited was used as the reflective member, and diffusion reflection characteristic RC2 indicates a reflection characteristic when “E6SV” made by Toray Industries, Inc. was used as the reflective member. Diffusion reflection characteristic RC3 indicates a reflection characteristic when a reflective member formed of polycarbonate (PC) was used.

TABLE 2

| | Reflectivity | Absorptivity | Transmittance |
|---|---|---|---|
| | (%) | (%) | (%) |
| RC1 (regular-reflection | 97 | 1 | 2 |
| characteristic) | | | |
| RC2 (diffusion reflection | 97 | 1 | 2 |
| characteristic) | | | |
| RC3 (diffusion reflection | 93 | 7 | 0 |
| characteristic) | | | |

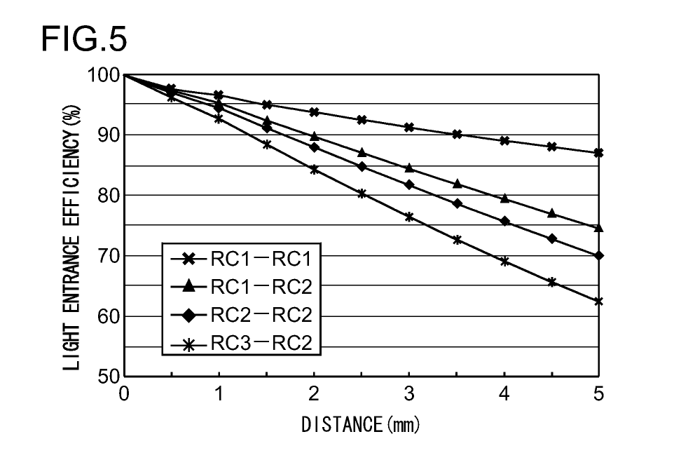

As a specific evaluation method, the light entrance efficiency of the light entrance surface 12c of the light guide plate 12 was checked in the following cases: a case where both the optically reflective surfaces 5a and 6a had regular-reflection characteristic RC1; a case where one of the optically reflective surfaces 5a and 6a had regular-reflection characteristic RC1 and the other had diffusion reflection characteristic RC2; a case where both the optically reflective surfaces 5a and 6a had diffusion reflection characteristic RC2; and a case where one of the optically reflective surfaces 5a and 6a had reflection characteristic RC3 and the other had reflection characteristic RC2. The results are shown in FIG. 5. In FIG. 5, the light entrance efficiency on the vertical axis indicates a ratio of the amount of light entering the light entrance surface 12c of the light guide plate 12 to the amount of luminous flux from the light-emitting surface 15a of the LED 15. The distance on the horizontal axis indicates a distance from the light-emitting surface 15a of the LED 15 to the light entrance surface 12c of the light guide plate 12.

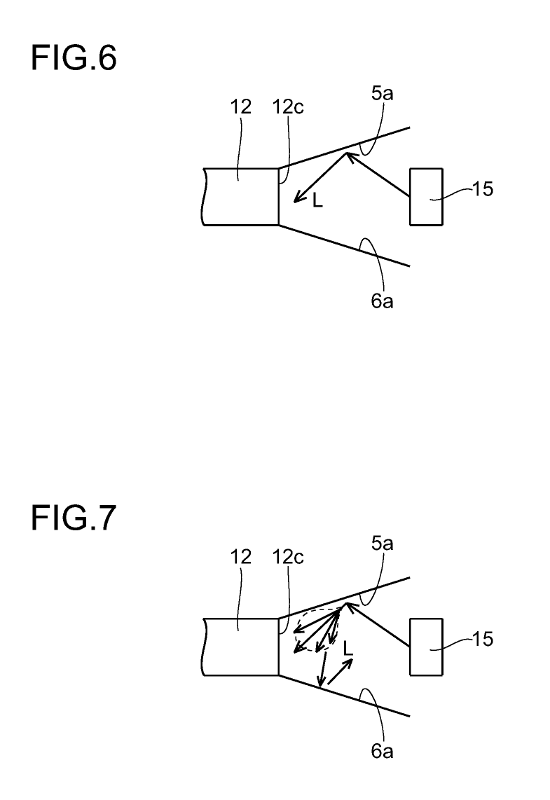

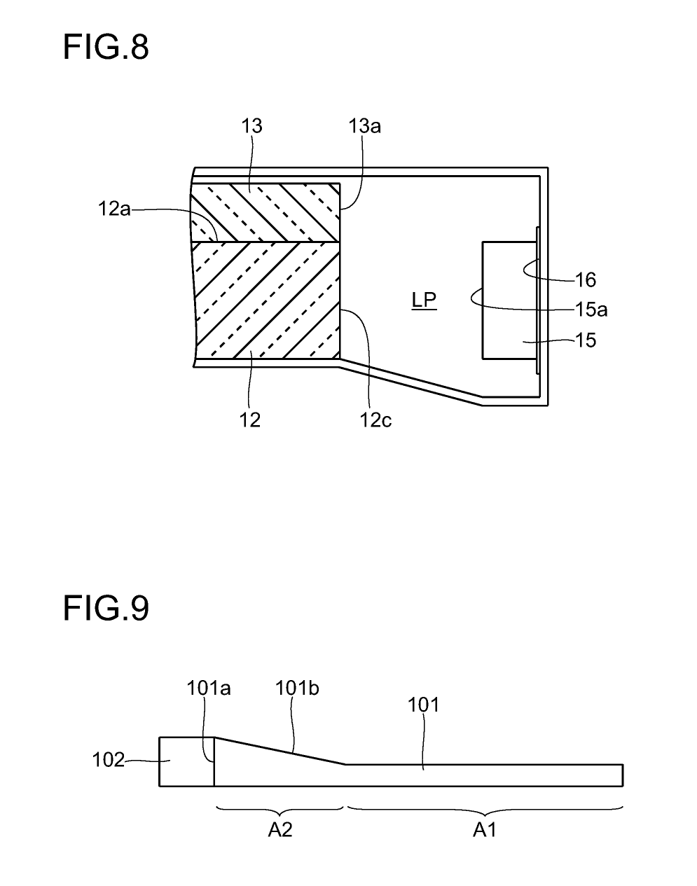

FIG. 5 shows that at least one of the optically reflective surfaces 5a and 6a has regular-reflection characteristic RC1, and thus it is possible to increase the light entrance efficiency. In particular, when both the optically reflective surfaces 5a and 6a had regular-reflection characteristic RC1, it was possible to significantly increase the light entrance efficiency as compared with the other cases. This indicates that, when at least one of (including both of) the optically reflective surfaces 5a and 6a has the regular-reflection characteristic, the amount of light L returning to the side of the LED 15 is reduced (see FIG. 6) whereas, when neither of the optically reflective surfaces 5a and 6a has the regular-reflection characteristic, the amount of light L returning to the side of the LED 15 is increased (see FIG. 7).

Furthermore, when regular-reflection characteristic RC1 and diffusion reflection characteristic RC2 are compared, their reflectivity, absorptivity and transmittance are the same but the light entrance efficiency is higher in regular-reflection characteristic RC1 than in diffusion reflection characteristic RC2. Hence, it is important for at least one of the optically reflective surfaces 5a and 6a to have regular-reflection characteristic RC1.

How the light entrance efficiency of the light entrance surface 12c of the light guide plate 12 was affected by making the side end surface 13a, on the side of the LED 15, of the optical sheets 13 arranged on the light emitting surface 12a of the light guide plate 12 flush with the light entrance surface 12c of the light guide plate 12 was evaluated.

Consequently, it was found that, when the side end surface 13a of the optical sheets 13 is made flush with the light entrance surface 12c of the light guide plate 12, as compared with the case where the optical sheets 13 are not arranged on the light emitting surface 12a of the light guide plate 12, the light entrance efficiency was reduced to about 80%. Hence, the following is probably true: when the side end surface 13a of the optical sheets 13 is made flush with the light entrance surface 12c of the light guide plate 12, the amount of light (lost light) which enters the side end surface 13a of the optical sheets 13 and which is absorbed and introduced is increased, and accordingly, the amount of light entering the light entrance surface 12c of the light guide plate 12 is reduced. Therefore, in order to increase the light entrance efficiency, it is preferable to make the side end surface 13a of the optical sheets 13 flush with the light entrance surface 12c of the light guide plate 12.

It should be considered that the embodiment disclosed herein is illustrative in all respects and not restrictive. The scope of the present invention is indicated not by the description of the embodiment discussed above but by the scope of claims; furthermore, the scope of the present invention includes meanings equivalent to the scope of claims and all modifications within the scope.

For example, although, in the embodiment discussed above, the example where the present invention is applied to the liquid crystal display device serving as the display device has been described, the present invention is not limited to this example. The present invention can be applied to display devices other than the liquid crystal display device.

Although, in the embodiment described above, the optical path LP is partitioned by the portions of the enclosure 3, the present invention is not limited to this configuration. The optical path LP may be partitioned by a member other than the enclosure 3.

Although, in the embodiment described above, the optically reflective sheets 5 and 6 are adhered to the predetermined portions of the enclosure 3 which partition the optical path LP, the present invention is not limited to this configuration. A highly reflective material may be applied to the predetermined portions of the enclosure 3 which partition the optical path LP; a highly reflective material may be used as the constituent material itself of the enclosure 3. In this way, it is not necessary to additionally prepare the optically reflective sheets 5 and 6.

Although, in the present embodiment, the optically reflective sheets 5 and 6 formed of the same highly reflective material are used, the present invention is not limited to this configuration. As long as the optically reflective sheets 5 and 6 have the regular-reflection characteristic, the constituent materials of the optically reflective sheets 5 and 6 may be different from each other.

Although, in the present embodiment, both the optically reflective surfaces 5a and 6a have the regular-reflection characteristic, the present invention is not limited to this configuration. At least one of the optically reflective surfaces 5a and 6a may have the regular-reflection characteristic. In other words, one of the optically reflective surfaces 5a and 6a may have the regular-reflection characteristic and the other may have the diffusion reflection characteristic. In this case, as compared with the case where both the optically reflective surfaces 5a and 6a have the regular-reflection characteristic, the light entrance efficiency of the light entrance surface 12c of the light guide plate 12 is slightly lowered.

Although, in the present embodiment, the light guide plate 12 and the optical sheets 13 are held with the enclosure 3, the present invention is not limited to this configuration. The light guide plate 12 and the optical sheets 13 may be held with another member.

### LIST OF REFERENCE SYMBOLS

1 liquid crystal display device (display panel, illuminated member)
2 LED backlight unit (illumination device)
3 enclosure (holding member)
5a optically reflective surface (first optically reflective surface)
5b portion (first portion)
6a optically reflective surface (second optically reflective surface)
6b portion (second portion)
12 light guide plate
12a light emitting surface (front surface)
12b back surface
12c light entrance surface (predetermined side end surface)
13 optical sheet
13a side end surface
A optical path region
LP optical path
LA LED arrangement region (the arrangement region of a light source)

1. An illumination device comprising:
a light guide plate which includes a front surface facing a side of an illuminated member, a back surface that is an opposite surface of the front surface and a plurality of side end surfaces connecting the front surface and the back surface, and in which a predetermined side end surface of the side end surfaces is a light entrance surface;
a light source which is arranged a predetermined distance away from the light entrance surface of the light guide plate so as to face the light entrance surface; and
an optical path which is formed of a space partitioned by a first optically reflective surface reaching a side of the light entrance surface of the light guide plate on a side of the front surface from an arrangement region of the light source and a second optically reflective surface reaching a side of the light entrance surface of the light guide plate on a side of the back surface from the arrangement region of the light source, and through which light from the light source is guided to the light entrance surface of the light guide plate,
wherein, in at least an optical path region, of the entire optical path, on a side of the light entrance surface of the light guide plate, the first optically reflective surface and the second optically reflective surface are arranged parallel to each other, and
a distance between the first optically reflective surface and the second optically reflective surface in the arrangement region of the light source is made greater than a distance between the first optically reflective surface and the second optically reflective surface in the optical path region on the side of the light entrance surface of the light guide plate.

2. The illumination device of claim 1,
wherein a first portion of the first optically reflective surface and a second portion of the second optically reflective surface are arranged parallel to each other, and
the first portion and the second portion are continuously extended from the side of the light entrance surface of the light guide plate to a side of the light source.

3. The illumination device of claim 2,
wherein the first portion and the second portion are continuously extended from the side of the light entrance surface of the light guide plate to the side of the light source such that a distance from an end of the optical path region, on the side of the light source, partitioned by the first portion and the second portion to the light source is set equal to or more than 0 mm but equal to or less than 0.5 mm.

4. The illumination device of claim 1,
wherein at least one of the first optically reflective surface and the second optically reflective surface has a regular-reflection characteristic.

5. The illumination device of claim 1, further comprising:
an optical sheet which is arranged on the front surface of the light guide plate facing the illuminated member,
wherein the optical sheet is displaced in a direction away from the light source with respect to the light guide plate such that a side end surface of the optical sheet on the side of the light source is prevented from being flush with the light entrance surface of the light guide plate.

6. The illumination device of claim 5, further comprising:
a holding member for holding the light guide plate and the optical sheet,
wherein a step is formed in the holding member, and
the front surface of the light guide plate facing the side of the illuminated member is pressed with a convex surface of the step of the holding member and a surface of the optical sheet facing the illuminated member is pressed with a concave surface of the step of the holding member.

7. A display device comprising:
the illumination device of claim 1 and
a display panel which is illuminated by the illumination device.
